(19) United States
(12) Patent Application Publication
(10) Pub. No.: US 2026/0140799 A1
(43) Pub. Date: May 21, 2026

(54) SYSTEM AND METHOD FOR API MANAGEMENT

(71) Applicant: The Toronto-Dominion Bank, Toronto (CA)

(72) Inventors: Mohamed ABBAS, Jersey City, NJ (US); Richard Bruce JOHNSON, Cape Elizabeth, ME (US); Levi SUTTER, Westampton, NJ (US); Eric Paul KAISER, JR., Auburn, ME (US)

(73) Assignee: The Toronto-Dominion Bank, Toronto (CA)

(21) Appl. No.: 18/951,930

(22) Filed: Nov. 19, 2024

(51) Int. Cl. G06F 9/54

(52) U.S. Cl. CPC G06F 9/547

(57) ABSTRACT

A computer-implemented method comprises identifying a particular API for performing at least one generic API function; engaging a bridge to translate the at least one generic API function into at least one particular available function of the particular API; generating at least one API request based on the at least one particular available function of the particular API; and sending to a server hosting the particular API, the at least one API request to perform the at least one particular available function. The bridge may define a mapping between the at least one generic API function and the at least one particular available function of the particular API using artificial intelligence.

### TECHNICAL FIELD

The present application relates to systems and methods for application programming interface (API) management.

### BACKGROUND

Application programming interfaces (APIs) enable systems to interact and share data. As the demand for API integration grows, excessive computing resources are consumed due to redundant or frequent API calls needed to retrieve data.

Further, APIs from various providers often lack standardization in data formats, authentication protocols, and endpoint configurations, creating inconsistencies that may lead to misinterpretation and unnecessary API calls. The lack of uniformity complicates API integration which may result in an unnecessary high consumption of computing resources.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 shows, in flowchart form, an example method for determining available functions of a particular API;

FIG. 4 shows, in flowchart form, an example method for defining a mapping between generic API functions and available functions for a particular API;

FIG. 5 shows, in flowchart form, an example method for constructing an API request template;

FIG. 6 shows, in flowchart form, an example method for defining a bridge that translates at least one generic API function into at least one available function of two or more APIs;

FIG. 7 is a schematic diagram of an example bridge;

FIG. 8 shows, in flowchart form, an example method for providing a graphical user interface;

FIG. 9 is an example graphical user interface;

FIG. 10 is another example graphical user interface;

FIG. 11 shows, in flowchart form, an example method for sending an API request to perform a requested function; and

FIG. 12 shows, in flowchart form, an example method for updating a graphical user interface.

Like reference numerals are used in the drawings to denote like elements and features.

### DETAILED DESCRIPTION OF VARIOUS EMBODIMENTS

Accordingly, in one aspect there is provided a server computer system comprising at least one processor; a communications module coupled to the at least one processor; and a memory coupled to the at least one processor, the memory storing instructions that, when executed, configure the at least one processor to send, via the communications module and to a computing device, a signal causing the computing device to display a graphical user interface that includes selectable interface elements for performing at least one generic application programming interface (API) function using a particular API of two or more APIs; receive, via the communications module and from the computing device, a signal indicating selection of one of the selectable interface elements for performing the at least one generic API function; identify the particular API for performing the at least one generic API function; engage a bridge to translate the at least one generic API function into at least one particular available function of the particular API; generate at least one API request based on the at least one particular available function of the particular API; and send, via the communications module and to a server hosting the particular API, the at least one API request to perform the at least one particular available function.

In one or more embodiments, when generating the at least one API request, the instructions, when executed, further configure the at least one processor to retrieve at least one API request template from a database based on the at least one particular available function of the particular API.

In one or more embodiments, the instructions, when executed, further configure the at least one processor to populate one or more dynamic values of the at least one API request template.

In one or more embodiments, the bridge translates the at least one generic API function into at least one available function of the two or more APIs.

In one or more embodiments, wherein the graphical user interface include a first selectable interface element for performing a first generic API function using a first API and a second interface element for performing the first generic API function using a second API.

In one or more embodiments, the particular API for performing the at least one generic API function is identified based on the selection of the one of the selectable interface elements.

In one or more embodiments, the instructions, when executed, further configure the at least one processor to receive, via the communications module and from the server hosting the particular API, a response to the at least one API request.

In one or more embodiments, the instructions, when executed, further configure the at least one processor to update the graphical user interface to display information obtained from the response to the at least one API request.

In one or more embodiments, the at least one generic API function includes at least one card management function and the particular API includes a card management API.

In one or more embodiments, the graphical user interface is displayed within a digital wallet application executing on the computing device.

According to another aspect there is provided a computer-implemented method comprising sending, via a communications module and to a computing device, a signal causing the computing device to display a graphical user interface that includes selectable interface elements for performing at least one generic application programming interface (API) function using a particular API of two or more APIs; receiving, via the communications module and from the computing device, a signal indicating selection of one of the selectable interface elements for performing the at least one generic API function; identifying the particular API for performing the at least one generic API function; engaging a bridge to translate the at least one generic API function into at least one particular available function of the particular API; generating at least one API request based on the at least one particular available function of the particular API; and sending, via the communications module and to a server hosting the particular API, the at least one API request to perform the at least one particular available function.

In one or more embodiments, when generating the at least one API request, the method further comprises retrieving at least one API request template from a database based on the at least one particular available function of the particular API.

In one or more embodiments, the method further comprises populating one or more dynamic values of the at least one API request template.

In one or more embodiments, the bridge translates the at least one generic API function into at least one available function of two or more APIs.

In one or more embodiments, the graphical user interface include a first selectable interface element for performing a first generic API function using a first API and a second interface element for performing the first generic API function using a second API.

In one or more embodiments, the particular API for performing the at least one generic API function is identified based on the selection of the one of the selectable interface elements.

In one or more embodiments, the method further comprises receiving, via the communications module and from the server hosting the particular API, a response to the at least one API request.

In one or more embodiments, the method further comprises updating the graphical user interface to display information obtained from the response to the at least one API request.

In one or more embodiments, the at least one generic API function includes at least one card management function and the particular API includes a card management API.

According to another aspect there is provided a non-transitory computer readable storage medium comprising processor-executable instructions which, when executed, configure at least one processor to send, via a communications module and to a computing device, a signal causing the computing device to display a graphical user interface that includes selectable interface elements for performing at least one generic application programming interface (API) function using a particular API of two or more APIs; receive, via the communications module and from the computing device, a signal indicating selection of one of the selectable interface elements for performing the at least one generic API function; identify the particular API for performing the at least one generic API function; engage a bridge to translate the at least one generic API function into at least one particular available function of the particular API; generate at least one API request based on the at least one particular available function of the particular API; and send, via the communications module and to a server hosting the particular API, the at least one API request to perform the at least one particular available function.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

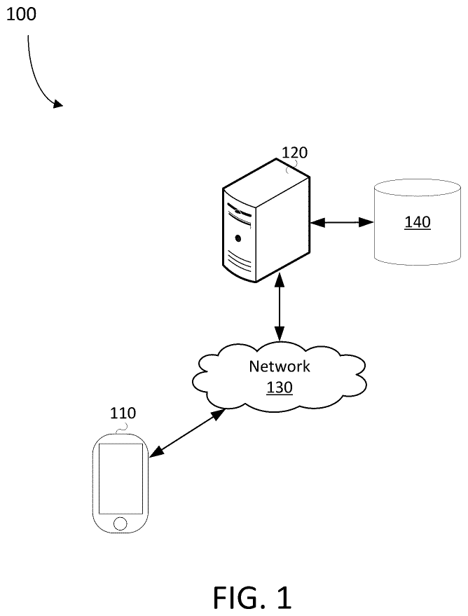

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may be associated with a user or customer having resources that are managed by or via the server computer system 120. For example, the server computer system 120 may be a financial institution server and the user may be a customer of a financial institution operating the financial institution server. The computing device 110 may store software instructions that cause the computing device 110 to establish communications with the server computer system 120.

The server computer system 120 may communicate with one or more third party servers through one or more application programming interfaces (APIs). Specifically, the server computer system 120 may facilitate interoperability with two or more external APIs while hosting an integrated application such as for example an application programming interface management application. In one or more embodiments, the server computer system 120 may include an API gateway that may serve as a central hub for routing API requests to the two or more external APIs.

Within the application programming interface management application, the server computer system 120 may present one or more graphical user interfaces that may include selectable interface elements for performing at least one generic API function. As will be described in more detail below, the server computer system 120 may define a bridge that translates at least one generic API function into at least one available function of the two or more external APIs. Further, the server computer system 120 may construct one or more API request templates that may be retrieved to generate API requests.

The server computer system 120 may maintain one or more databases 140 that may store data such as for example the bridge that translates the at least one generic API function into at least one available function of the two or more external APIs and/or the one or more API request templates that may be retrieved to generate API requests.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

Although not shown, in one or more embodiments, the system 100 may include one or more third party servers that may be associated with a third party that provides a particular service. For example, the third party server may be associated with a streaming service provider, a utility service provider, an internet provider, a cable provider, a third party financial institution, a credit card provider, etc.

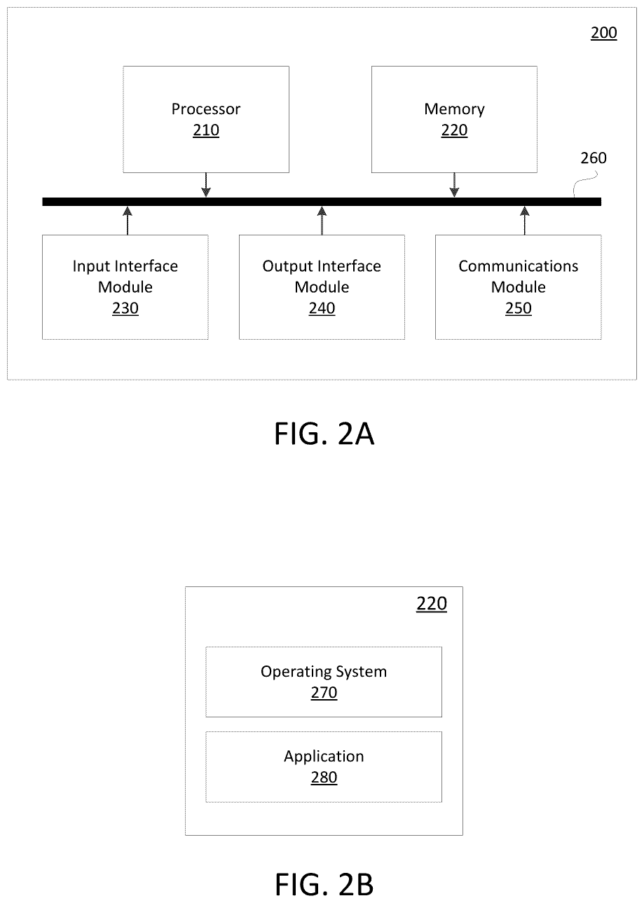

FIG. 2A is a high-level operation diagram of an example computer device 200. In some embodiments, the example computer device 200 may be exemplary of one or more of the computing device 110 and/or the server computer system 120. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi™, using Bluetooth™ or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS™, Google Android™, Linux™, Microsoft Windows™, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations.

For example, in at least some embodiments in which the computer device 200 is functioning as the computing device 110, the applications 280 may include an application programming interface (API) management application. The API management application may be configured for secure communications with the server computer system 120 and may provide various API management functions such as for example the ability to add or link one or more APIs, the ability to generate API requests, and other API management functions. The API management application may be configured to present a graphical user interface that includes selectable interface elements for performing one or more generic API functions for each API linked thereto. As will be described in more detail below, the API management application may present the selectable interface elements for performing one or more generic API functions in a consistent manner for all APIs linked thereto and this may be done to avoid the risk of performing unnecessary or redundant API functions that may result in a waste or unnecessary use of computing resources.

The API management application may be configured to link one or more APIs that may share a common characteristic or may be offered by similar providers. For example, in one or more embodiments, the API management application may be configured to engage with one or more card management APIs associated with one or more payment cards such as for example credit cards. In these embodiments, the API management application may be referred to as or may include a digital wallet application. The digital wallet application may be configured to present a graphical user interface that includes selectable interface elements for performing one or more card management functions for each payment card linked thereto. As will be described in more detail below, the digital wallet application may present the selectable interface elements for performing one or more card management functions in a consistent manner for all credit cards linked thereto and this may be done to avoid the risk of performing unnecessary or redundant card management functions that may result in a waste or unnecessary use of computing resources.

In one or more embodiments, a user or operator of the computing device 110 may be required to provide authentication information to access the API management application. For example, using the computing device 110, the user may enter a username and password and the computing device 110 may send a signal that includes the username and password to the server computer system 120. The server computer system 120 may verify the authentication information and may identify an account of the user retrieve data or information relating thereto for presentation on the computing device 110.

Within the API management application, interface elements may be presented for linking one or more APIs thereto. For example, the user may select an interface element to add or link an API thereto. Responsive to selection of the interface element, the user may be presented with a list of all APIs available to be linked to the API management application and the user may select one or more of the APIs from the list.

In one or more embodiments, the user may be required to provide authentication information to allow the API management application to access the linked APIs. For example, using the computing device 110, the user may enter a username and password associated with a particular API and the computing device 110 may send a signal that includes the username and password to the server computer system 120. The server computer system 120 may verify the authentication information and may use the authentication information to access an account of the user by way of the selected API.

As mentioned, the API management application may be configured to link one or more APIs that may share a common characteristic or may be offered by similar providers. As such, responsive to selection of the interface element to add or link one or more APIs, the user may be presented with a list of all API providers that have APIs available to be linked. The user may select one of the APIs providers and in response the list of API providers may be updated to include only API providers that are known to share a common characteristic with the selected API or that are known to be offered by similar providers as the provider of the selected API.

As mentioned, in one or more embodiments, the API management application may include a digital wallet application that may be configured to engage with one or more card management APIs associated with one or more payment cards such as for example credit cards. In these embodiments, interface elements may be presented for linking one or more credit card accounts thereto. For example, the user may select an interface element to add or link a credit card account thereto. Responsive to selection of the interface element, the user may be presented with a list of all credit card providers that have APIs available to be linked to the digital wallet application and the user may select one or more of the credit card providers from the list.

In one or more embodiments, the user may be required to provide authentication information to allow the digital wallet application to access the linked credit card accounts. For example, using the computing device 110, the user may enter a username and password associated with a particular credit card account and the computing device 110 may send a signal that includes the username and password to the server computer system 120. The server computer system 120 may verify the authentication information and may use the authentication information to access an account of the user by way of the API associated with the credit card provider. It will be appreciated that in one or more embodiments the server computer system 120 may require permission to access the account and this may be provided by the user. For example, a third party server associated with the credit card account may send a request to the computing device 110 of the user asking the user to grant permission to the server computer system 120 to access their account.

The API management application may present selectable interface elements for performing one or more generic API functions in a consistent manner for all APIs linked thereto and this may be done to avoid the risk of performing unnecessary or redundant API functions that may result in a waste or unnecessary use of computing resources.

The server computer system 120 determines available functions of each API and defines a mapping between one or more generic API functions and at least one available function of each API.

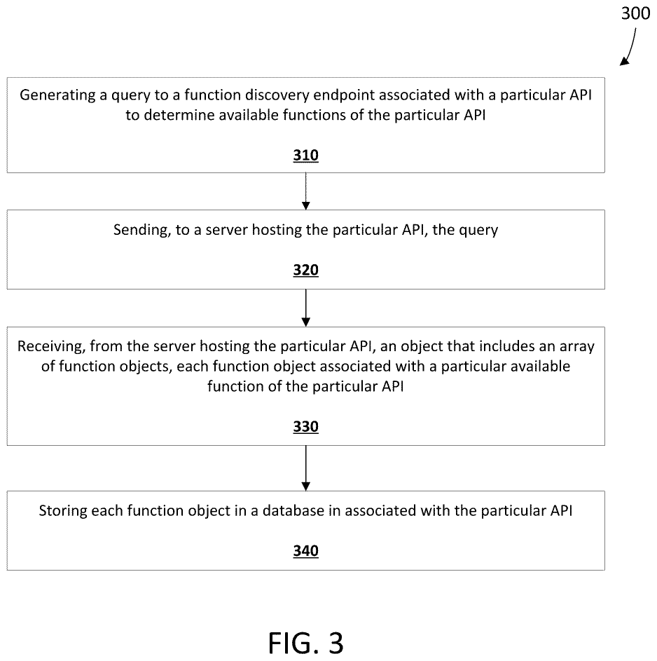

Reference is made to FIG. 3, which illustrates, in flowchart form, a method 300 for determining available functions of a particular API. The method 300 may be implemented by a computing device having suitable processor-executable instructions for causing the computing device to carry out the described operations. The method 300 may be implemented, in whole or in part, by the server computer system 120. The server computer system 120 may off-load some operations of the method 300 to the computing device 110 (FIG. 1).

The method 300 includes generating a query to a function discovery endpoint associated with a particular API to determine available functions of the particular API (step 310).

The server computer system 120 generates a query to a function discover endpoint associated with the particular API. In one or more embodiments, the query may include a GET request that indicates that the server computer system 120 would like to receive an organized list of all available functions within the API.

In one or more embodiments, the query may include an API token that may have been previously obtained by the server computer system 120. The API token may be used to ensure that only authorized systems can access function information.

The query may also specify the content type being requested which may include, for example, JavaScript Object Notation (JSON).

The query may also include a Uniform Resource Location (URL) that may be used to direct the query to a server hosting the particular API. The URL may include the API provider's base URL and the function discovery endpoint.

The method 300 includes sending, to a server hosting the particular API, the query (step 320).

The query may then be sent to a server hosting the particular API and this may be done based on the URL included in the query. The query may specifically be sent to the function discovery endpoint.

The method 300 includes receiving, from the server hosting the particular API, an object that includes an array of function objects, each function object associated with a particular available function of the particular API (step 330).

The server hosting the particular URL may process the query and send a response back. For example, the server may evaluate the query, check any authentication or authorization requirements, retrieve the available function information, and may return a structured response in the requested format (JSON).

The server computer system 120 receives the response which includes an object including an array of function objects, where each function object is associated with a particular function of the particular API. In one or more embodiments, each function object may define at least one of a name, a description, an endpoint, a method, require parameters, optional parameters, a rate limit, authentication level, or support actions for the particular available function.

In embodiments where the particular API includes a card management API, available functions may include, for example, balance inquiry, transaction history, account statement download, spending limit management, card activation, temporary card lock/unlock, Pin management, fraud detection and alerts, real-time transaction alerts, dispute transaction, card replacement request, rewards and points balance inquiry, redeem rewards, interest rate inquiry, minimum payment due inquiry, payment due date inquiry, make a payment, credit limit inquiry, add authorized user, billing address update, etc. The available functions include an array of operations that may enable a user to manage their credit card, monitor spending, enhance security, and maintain account information.

The method 300 includes storing each function object in a database in association with the particular API (step 340).

The server computer system 120 may store each function object in a database in association with the particular API. The database may include the database 140 described herein.

It will be appreciated that the server computer system 120 may periodically perform the operations of the method 300, such as for example every day or week, and this may be done to ensure that the available functions of the particular API are monitored and updated by the server computer system 120.

As mentioned, the server computer system 120 determines available functions of each API and defines a mapping between one or more generic API functions and at least one available function of each API.

The server computer system 120 may maintain a list of generic API functions and may store the list in the database. The list may be stored such that each generic API functions may be labelled with one or more labels or tags that may be used to characterize the generic API function. For example, the server computer system 120 may maintain a list of generic card management API functions and may store the list in the database where each generic card management API function may be labelled “card management”. The list may include, for example, balance inquiry, transaction history, spending limit management, etc. This list may be generated during, for example, a configuration process of the API management application.

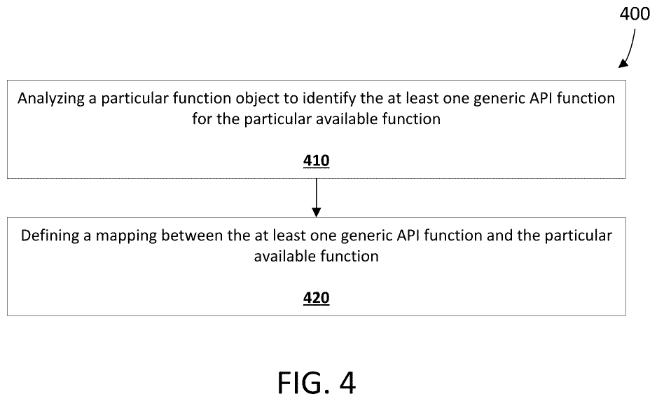

The server computer system 120 may then define a mapping between generic API functions and available API functions for a particular API. Reference is made to FIG. 4, which illustrates, in flowchart form, a method 400 for defining a mapping between generic API functions and available API functions for a particular API. The method 400 may be implemented by a computing device having suitable processor-executable instructions for causing the computing device to carry out the described operations. The method 400 may be implemented, in whole or in part, by the server computer system 120. The server computer system 120 may off-load some operations of the method 400 to the computing device 110 (FIG. 1).

The method 400 includes analyzing a particular function object to identify at least one generic API function for the particular available function (step 410).

As mentioned, during the method 300, the server computer system 120 may obtain function objects associated with particular functions of the particular API where each function object may define at least one of a name, a description, an endpoint, a method, require parameters, optional parameters, a rate limit, authentication level, or support actions for the particular available function.

The server computer system 120 may analyze the function object to identify the at least one generic API function. For example, the function object may be analyzed to identify the at least one generic API function and this may be done by identifying, for example, one or more keywords within the description. In this example, a function object for a card management API may include a description “retrieves the current balance on a specified credit card account, including available credit and outstanding balance amounts.” The keywords “balance” and “credit card account” may be used to identify at least one generic API function as “balance inquiry.”

In one or more embodiments, the server computer system 120 may utilize artificial intelligence (AI) to analyze the function objects and identify the at least one generic function associated therewith. For example, the server computer system 120 may train the AI module using a supervised learning approach with natural language processing and pattern recognition techniques.

To train the AI module, the server computer system 120 may create the list of generic API functions and may define a set of identifying keywords, phrases, or parameter structures that commonly appear across different implementations. For example, a generic API function of “balance inquiry” may include keywords like “balance”, “available credit”, “outstanding balance.”

The server computer system 120 may generate training data at least by gathering a dataset of function objects from different APIs that includes diverse representations of similar functions. Each function object in the training data may be labelled with the appropriate generic API function label. The training data may be tokenized and the function object fields may be preprocessed. The training data may be cleaned to convert text to lowercase letters, to remove special characters, etc.

The server computer system 120 may then extract features from the function objects that may help differentiate function types and these features may be converted into numerical representations using NLP models.

During training, the server computer system 120 may utilize a supervised classification model. The model may be trained to classify each function object into one of the generic API functions. The model may then be evaluated using a validation dataset and one or more hyperparameters may be tuned or adjusted to improve the model's accuracy in correctly identifying generic API functions.

The method 400 includes defining a mapping between the at least one generic API function and the particular available function for the particular API (step 420).

Responsive to identifying at least one generic API function of a particular available function of a particular API, the server computer system 120 may define a mapping between the at least one generic API function and the particular available function for the particular API. The mapping may then be stored in the database.

It will be appreciated that in one or more embodiments, more than one particular available function of a particular API may be mapped to a particular generic API function. For example, during the step 410, a first generic API function may be identified for a first available function and a second available function of a first particular API. As such, the first generic API function may be mapped to both the first available function and the second available function. It will be appreciated that the generic API function may be mapped to a single available function of another API. For example, during the step 410, the first generic API function may be identified for a first available function of a second particular API. As such, the first generic API function may be mapped to the first available function of the second particular API. In embodiments where the first particular API and the second particular API may be linked within the API management application, the first generic API function may be mapped to the first available function and the second available function of the first particular API and may also be mapped to the first available function of the second particular API.

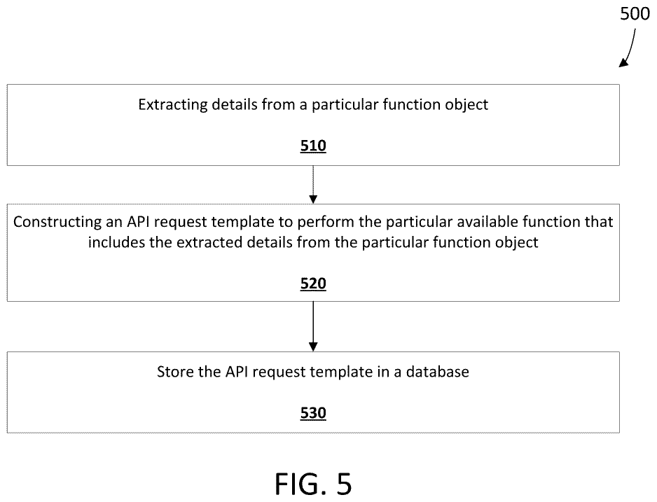

In addition to identifying at least one generic API function of a particular available function of a particular API, the server computer system 120 may additionally construct an API request template for the particular available function that may be stored in the database and later retrieved to generate an API request. Reference is made to FIG. 5, which illustrates, in flowchart form, a method 500 for constructing an API request template. The method 500 may be implemented by a computing device having suitable processor-executable instructions for causing the computing device to carry out the described operations. The method 500 may be implemented, in whole or in part, by the server computer system 120. The server computer system 120 may off-load some operations of the method 500 to the computing device 110 (FIG. 1).

The method 500 includes extracting details from a particular function object (step 510).

As mentioned, during the method 300, the server computer system 120 may obtain function objects associated with particular functions of the particular API where each function object may define at least one of a name, a description, an endpoint, a method, require parameters, optional parameters, a rate limit, authentication level, or support actions for the particular available function.

The server computer system 120 may extract details from the particular function object that may be required for the API request template. For example, the server computer system 120 may extract the endpoint URL, query parameters, the HTTP method, headers that may be required, parameters such as path parameters, query parameters, body parameters, and permissions such as for example permissions or scopes for certain functions and this may be done to ensure that the server computer system 120 has the necessary access rights to make the API request.

The method 500 includes constructing an API request template to perform the particular available function that includes the extracted details from the particular function object (step 520).

Using the extracted details from the particular function object, the server computer system 120 may contract an API request template to perform the particular available function. The API request template includes computer program code that may be executed to complete the API request. The computer program code may include or otherwise define a function name and description, the endpoint URL with placeholders for path parameters, the necessary headers including placeholders for tokens or other dynamic values, path parameters that specify parameters embedded in the URL path, a body such as for example a JSON body with placeholders to be replaced by actual values, the required parameters which may include a list of parameters required to make a valid API call, and permissions which may indicate the permission level needed to access. The API request template is structured to provide all essential details for easily retrieving and populating parameters for a consistent and resource-efficient API request.

The method 500 includes storing the API request template in a database (step 530).

The API request template is stored in the template where it may be later retrieved to generate an API request to perform the particular available function. In this manner, the API request template may be retrieved from the database, any placeholders may be replaced by actual values, and the API request may be sent. For example, the API request template may be queried by name and may be populated with actual values.

As one example, an API request template may be constructed for setting a spending limit on a payment card. The API request template may be named “setSpendingLimit” and may require values “CardID”, “limitType”, and “amount”. As such, the API request template may be queried using “setSpendingLimit(“12345”, “daily”, 500.00) and this may be done to generate an API request to set a daily spending limit of $500.00 on credit card 12345.

As will be appreciated, by storing the API request template in the database, the server computer system 120 may eliminate the requirement of dynamically constructing each API request from scratch. This results in fewer computations to build request headers, endpoints, and parameters for each call resulting in faster execution times. Further, since the API request templates are stored in the database, they do not need to be loaded into memory multiple times across different parts of the system. Rather, the server computer system 120 may retrieve the API request template only when it is needed, which minimizes memory usage especially in applications with many different API calls. Further, the API request templates reduce processing overhead associated with formatting, validating and debugging repetitive API request construction steps. The computing resources required to process the API requests is reduced as the server computer system 120 does not need to repeatedly create and validate API requests but rather may retrieve ready-made API request templates. Additionally, the API request templates ensure that each API request has the correct structure, reducing the risk of poorly formatted requests or missing parameters, which may lead to errors and additional retries. Reducing errors results in reduced processing and network resources.

The server computer system 120 may perform the method 500 for all available functions for each API that may be made available within the API management and in this manner an API request template may be made available within the database for all available functions for all APIs available to be linked within the API management application.

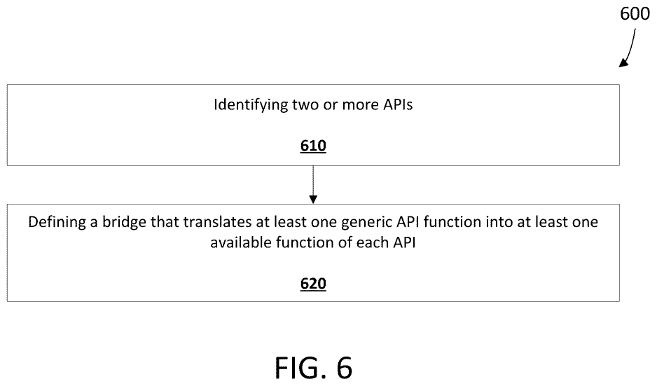

As mentioned, the server computer system 120 may define a bridge that translates at least one generic API function into at least one available function of the two or more external APIs. Reference is made to FIG. 6, which illustrates, in flowchart form, a method 600 for defining a bridge that translates at least one generic API function into at least one available function of two or more APIs. The method 600 may be implemented by a computing device having suitable processor-executable instructions for causing the computing device to carry out the described operations. The method 600 may be implemented, in whole or in part, by the server computer system 120. The server computer system 120 may off-load some operations of the method 600 to the computing device 110 (FIG. 1).

The method 600 includes identifying two or more APIs (step 610).

In one or more embodiments, the server computer system 120 may identify two or more APIs based on a common characteristic or based on them being offered by similar providers. For example, two or more APIs may be linked or otherwise categorized based on a common characteristic and as such the two or more APIs may be identified based on the link.

For example, in one or more embodiments, the API management application may be configured to engage with one or more card management APIs associated with one or more payment cards such as for example credit cards. In these embodiments, the server computer system 120 may identify two or more card management APIs.

In one or more embodiments, the server computer system 120 may identify the two or more APIs based on the two or more APIs being linked by a user within the API management application. For example, a user may link a first API and a second API within the API management application and as such the server computer system 120 may identify the two or more APIs as including the first API and the second API.

The method 600 includes defining a bridge that translates at least one generic API function into at least one available function of each API (step 620).

The server computer system 120 defines a bridge that may be used to translate at least one generic API function into at least one available function of each API.

In one or more embodiments, the bridge may include the mapping between the at least one generic API function and the particular available function of each API. For example, the mapping defined during the method 400 described herein and stored in the database may be included. As such, the mapping may be used to link the at least one generic API function to the at least one available function of the two or more APIs identified during step 610.

In one or more embodiments, the bridge may include the API request template for each available function of the two or more APIs. For example, the API request templates constructed during the method 500 described herein and stored in the database may be included.

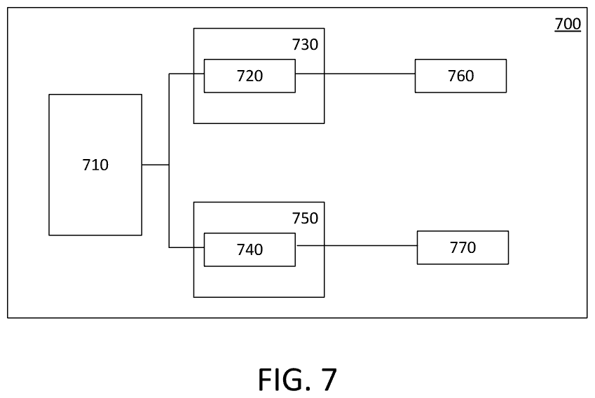

A schematic diagram of an example bridge 700 is shown in FIG. 7. As can be seen, the bridge includes a generic API function 710. The generic API function 710 is mapped to a first available function 720 of a first API 730 and to a second available function 740 of a second API 750. The first available function 720 of the first API 730 is linked to a first API request template 760 and the second available function 740 of the second API 750 is linked to a second API request template 770.

The bridge 700 translates the at least one generic API function into the first available function 720 of the first API 730 and the second available function 740 of the second API 750 and this may be done by retrieving the first API request template 760 and the second API request template 770.

As mentioned, the at least one generic API function may be mapped to more than one available functions of a particular API. For example, a first generic API function may be mapped to a first available function and a second available function of a particular API. As such, the bridge may translate the first generic API function into the first available function and the second available function of the particular API and this may be done by retrieving an API request template of the first available function and an API request template of the second available function.

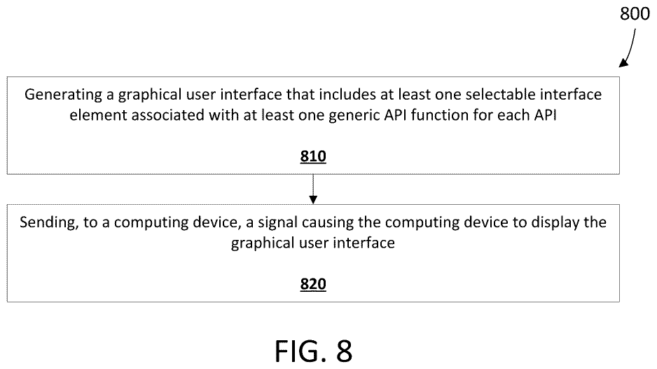

The bridge may be utilized within the API management application to enable a user to request the at least one generic API function for one of two or more APIs and this may be done through use of one or more graphical user interfaces provided by the server computer system 120. Reference is made to FIG. 8, which illustrates, in flowchart form, a method 800 for providing a graphical user interface. The method 800 may be implemented by a computing device having suitable processor-executable instructions for causing the computing device to carry out the described operations. The method 800 may be implemented, in whole or in part, by the server computer system 120. The server computer system 120 may off-load some operations of the method 800 to the computing device 110 (FIG. 1).

The method 800 includes generating a graphical user interface that includes at least one selectable interface element associated with at least one generic API function for each API (step 810).

The server computer system 120 may generate the graphical user interface based on the two or more APIs linked within the API management application. The at least one generic API function may include a single generic API function for each API or may include multiple generic API functions for each API.

The at least one selectable interface element associated with at least one generic API function for each API may be linked or may be otherwise associated with the bridge that may be used to translate at least one generic API function into at least one available function of each API. For example, selection of the at least one selectable interface element may trigger the translation of the at least one generic API function into an available function of a particular API in manners similar to that described herein, for example, that described herein with reference to FIG. 7.

As one example, the API management application may be configured to engage with two or more card management APIs associated with one or more payment cards such as for example credit cards. As such, the graphical user interface may include a selectable interface element associated with generic API functions for each card management API linked thereto. The generic API function may include at least one card management function.

The method 800 includes sending, to a computing device, a signal causing the computing device to display the graphical user interface (step 820).

The signal is sent to cause the computing device to display the graphical user interface within the API management application. In embodiments where the API management application includes a digital wallet application, the graphical user interface may be displayed within the digital wallet application.

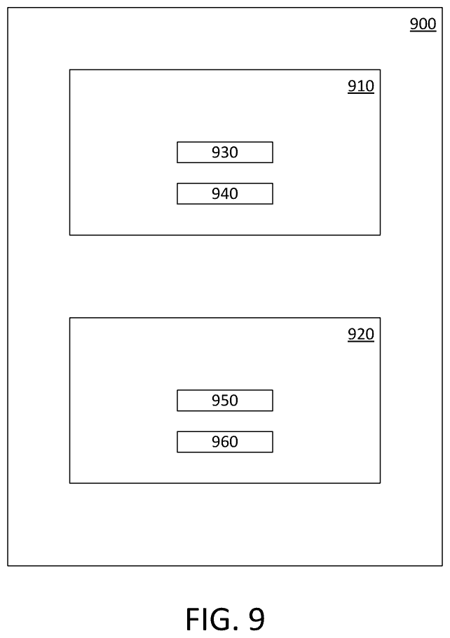

An example graphical user interface 900 is shown in FIG. 9. As can be seen, the graphical user interface 900 displays a first graphic element 910 representing a first API and a second graphic element 920 representing a second API. The graphic element 910 includes a first selectable interface element 930 for performing a first generic API function and a second selectable interface element 940 for performing a second generic API function. The graphic element 920 includes a first selectable interface element 950 for performing the first generic API function and a second selectable interface element 960 for performing the second generic API function. The example graphical user interface 900 presents the graphic elements and the selectable interface elements in a consistent manner for all APIs linked thereto.

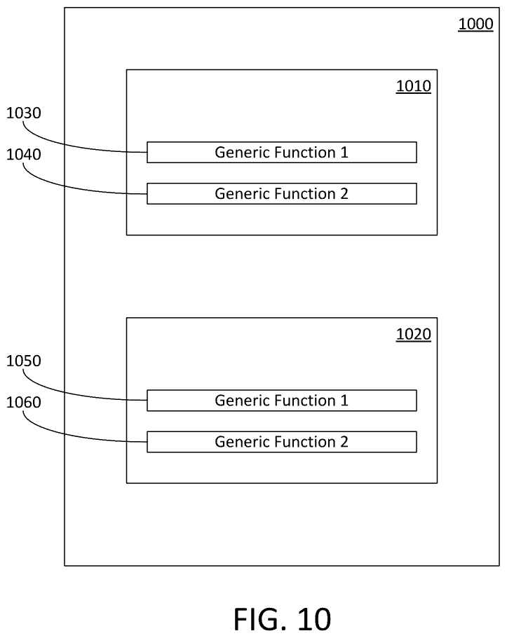

Another example graphical user interface 1000 is shown in FIG. 10. As can be seen, the graphical user interface 1000 displays a first graphic element 1010 representing a first card management API and a second graphic element 1020 representing a second card management API. The graphic element 1010 includes a first selectable interface element 1030 for performing a first generic card management function and a second selectable interface element 1040 for performing a second generic card management function. The graphic element 1020 includes a first selectable interface element 1050 for performing the first generic card management function and a second selectable interface element 1060 for performing the second generic card management function. The example graphical user interface 1000 presents the graphic elements and the selectable interface elements in a consistent manner for all card management APIs linked thereto. In this example, the server computer system 120 presents the selectable interface elements for performing one or more card management functions in a consistent manner for all credit cards linked thereto and this may be done to avoid the risk of performing unnecessary or redundant card management functions that may result in a waste or unnecessary use of computing resources.

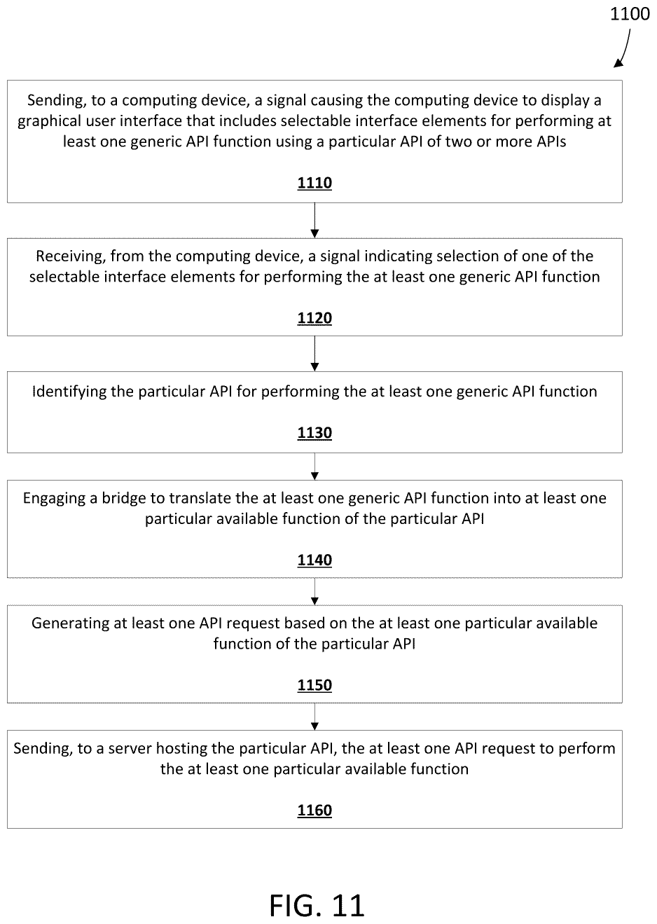

The selectable interface elements for performing the one or more generic API functions may be selected by a user indicating a request to perform a function and in response the server computer system 120 may perform operations to send an API request to perform the requested function. Reference is made to FIG. 11, which illustrates, in flowchart form, a method 1100 for sending an API request to perform a requested function. The method 1100 may be implemented by a computing device having suitable processor-executable instructions for causing the computing device to carry out the described operations. The method 1100 may be implemented, in whole or in part, by the server computer system 120. The server computer system 120 may off-load some operations of the method 1100 to the computing device 110 (FIG. 1).

The method 1100 includes sending, to a computing device, a signal causing the computing device to display a graphical user interface that includes selectable interface elements for performing at least one generic application programming interface (API) function using a particular API of two or more APIs (step 1110).

The signal may cause the graphical user interface to be displayed on the computing device within the API management application. In embodiments where the API management application includes a digital wallet application, the signal may cause the graphical user interface to be displayed within the digital wallet application.

In one or more embodiments, the graphical user interface may include the same selectable interface elements for each API linked within the API management application where each selectable interface element may be associated with a particular API. For example, the graphical user interface may include a first selectable interface element for performing a first generic API function using a first API and a second selectable interface element for performing the first generic API function using a second API. As another example, the graphical user interface may include a third selectable interface element for performing a second generic API function using the first API and a fourth selectable interface element for performing the second generic API function using the second API.

It will be appreciated that the graphical user interface may include multiple selectable interface elements for each API where each selectable interface element is associated with a particular generic API function.

In one or more embodiments, the graphical user interface may be similar to the graphical user interface 900 and/or the graphical user interface 1000 described herein.

It will be appreciated that the graphical user interface may display information relating to each generic API function. For example, the generic API function may include “balance inquiry” and as such the graphical user interface may display the generic API function adjacent to or as part of the selectable interface element for requesting the balance inquiry.

The method 1100 includes receiving, from the computing device, a signal indicating selection of one of the selectable interface elements for performing the at least one generic API function (step 1120).

The user may select a selectable interface element by performing, for example, a tap gesture on a display screen of the computing device at a location that corresponds to a location of the one of the selectable interface elements. In response, the computing device may send the signal indicating selection of one of the selectable interface elements for performing the at least one generic API function. The signal may identify the interface element that was selected and this may indicate the particular API for performing the at least one generic API function and the at least one generic API function. In response, the server computer system 120 receives the signal indicating selection of one of the selectable interface elements for performing the at least one generic API function.

The method 1100 includes identifying the particular API for performing the at least one generic API function (step 1130).

The server computer system 120 may identify the particular API based on the selection of the one of the selectable interface elements. For example, as mentioned, the signal received from the computing device indicating selection of one of the selectable interface element for performing the at least one generic API function may identify the interface element that was selected and this may indicate the particular API for performing the at least one generic API function and the at least one generic API function. In this manner, the server computer system 120 may identify the particular API for performing the at least one generic API function.

The method 1100 includes engaging a bridge to translate the at least one generic API function into at least one particular available function of the particular API (step 1140).

Once the particular API for performing the at least one generic API function has been identified, the server computer system 120 may engage the bridge to translate the at least one generic API function into at least one particular available function of the particular API.

The bridge may include the bridge defined during the method 600 described herein. In one or more embodiments, the bridge may include the mapping between the at least one generic API function and the at least one particular available function of the particular API. For example, the mapping defined during the method 400 described herein and stored in the database may be included in the bridge. As such, the mapping may be used to link the at least one generic API function to the at least one particular available function of the particular API. In this manner, the at least one particular available function of the particular API may be identified.

Further, as mentioned, the bridge may include the API request template for the at least one particular available function of the particular API. The API request template may include an API request template constructed during the method 500 described herein and stored in the database. As such, the server computer system 120 may retrieve the at least one API request template from the database based on the at least one particular available function of the particular API.

As mentioned, the at least one generic API function may be mapped to more than one available functions of a particular API. For example, a first generic API function may be mapped to a first available function and a second available function of a particular API. As such, the bridge may translate the first generic API function into the first available function and the second available function of the particular API and this may be done by retrieving an API request template of the first available function and an API request template of the second available function.

The method 1100 includes generating at least one API request based on the at least one particular available function of the particular API (step 1150).

Once the API request template for performing the at least one particular available function has been retrieved from the database, the server computer system 120 may perform operations to populate one or more dynamic values. For example, an API request template may be retrieved for setting a spending limit on a payment card. The API request template may be named “setSpendingLimit” and may require values “CardID”, “limitType”, and “amount”. As such, the API request template may be queried using “setSpendingLimit(“12345”, “daily”, 500.00) and this may be done to generate an API request to set a daily spending limit of $500.00 on credit card 12345. In this manner, the server computer system 120 may populate one or more dynamic values of the at least one API request template to generate the at least one API request.

In embodiments where more than one API request template is retrieved from the database, such as for example in embodiments where the at least one generic API function is mapped to two or more particular available functions of the particular API, the server computer system 120 may generate more than one API request.

The method 1100 includes sending, to a server hosting the particular API, the at least one API request to perform the at least one particular available function (step 1160).

The server computer system 120 sends the at least one API request to the server hosting the particular API. For example, the API request may include a specific URL path directing the API request to an endpoint of the server hosting the particular API.

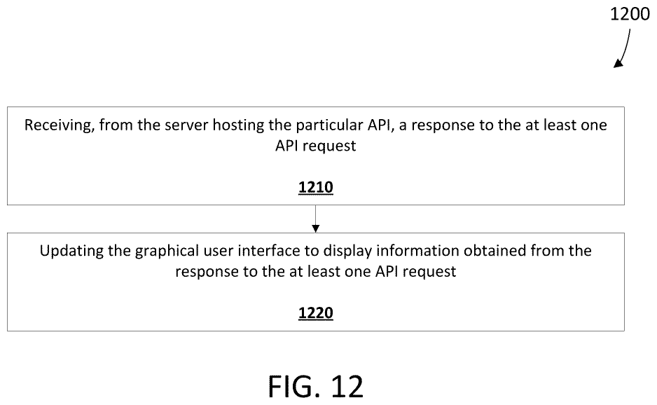

The server hosing the particular API may receive the request and may perform operations to process the request and may send, to the server computer system 120, a response to the API request and in response the server computer system 120 may perform one or more operations such as updating the graphical user interface. Reference is made to FIG. 12, which illustrates, in flowchart form, a method 1200 for updating a graphical user interface. The method 1200 may be implemented by a computing device having suitable processor-executable instructions for causing the computing device to carry out the described operations. The method 1200 may be implemented, in whole or in part, by the server computer system 120. The server computer system 120 may off-load some operations of the method 1200 to the computing device 110 (FIG. 1).

The method 1200 includes receiving, from the server hosting the particular API, a response to the at least one API request (step 1210).

As mentioned, the server hosting the particular API may perform operations to process the at least one API request and may send a response thereto. The server computer system 120 may receive the response from the server hosting the particular API.

The method 1200 includes updating the graphical user interface to display information obtained from the response to the at least one API request (step 1220).

The server computer system 120 may analyze the response to identify information to be displayed. For example, the at least one API request may include a request to obtain an updated account balance of a credit card account and as such the server computer system 120 may retrieve the updated account balance from the response to the at least one API request. The server computer system 120 may then update the graphical user interface such that the updated account balance is displayed thereon. For example, the server computer system 120 may send a signal to the computing device causing the computing device to update the graphical user interface or to display the updated graphical user interface.

As will be appreciated, through use of the API template, the server computer system 120 may eliminate the requirement of dynamically constructing the API request from scratch. This results in fewer computations to build request headers, endpoints, and parameters resulting in faster execution times. Further, since the API request template is stored in the database, it does not need to be loaded into memory multiple times across different parts of the system. Rather, the server computer system 120 may retrieve the API request template only when it is needed, which minimizes memory usage. Further, the API request template reduces processing overhead associated with formatting, validating and debugging. The computing resources required to process the API request is reduced as the server computer system 120 does not need to create and validate the API request but rather may retrieve the ready-made API request template. Additionally, the API request template ensures that the API request has the correct structure, reducing the risk of poorly formatted requests or missing parameters, which may lead to errors and additional retries. Reducing errors results in reduced processing and network resources.

In embodiments described, the API management application may present the selectable interface elements for performing one or more generic API functions in a consistent manner for all APIs linked thereto and this may be done to avoid the risk of performing unnecessary or redundant API functions that may result in a waste or unnecessary use of computing resources.

As one example, a first card management API may include an available API function named “GetAccountBalance” that uses a “GET” method. The available API function may have a particular endpoint (/v1/accounts/{accountId}/balance), primary identifier (accountId), optional parameter (includeCreditLimit) to toggle credit limit information, and a response format of a JSON object with balance, currency, available credit, credit limit, and outstanding balance. A second card management API may include an available function named “RetrieveCardBalance” that uses a “POST” method. The available API function may have a particular endpoint (/api/cards/balance), primary identifier (cardID), optional parameter (showBalanceinCurrency) to specify currency, authentication method (X-Api-Key), and a response format of a JSON object with outstanding amount, available balance, and currency with no credit limit. These APIs have variations in endpoint structure, parameter names, HTTP methods, and response formats and as such it may be difficult to integrate these APIs even when the functions serve a similar purpose. As such, in accordance with embodiments described herein, at least one generic API function may be defined and mapped to the available API functions of the first card management API and the second card management API and this may be done to present selectable interface elements for performing the API functions in a consistent manner.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

1. A server computer system comprising:
at least one processor;
a communications module coupled to the at least one processor; and
a memory coupled to the at least one processor, the memory storing instructions that, when executed, configure the at least one processor to:
send, via the communications module and to a computing device, a signal causing the computing device to display a graphical user interface that includes selectable interface elements for performing at least one generic application programming interface (API) function using a particular API of two or more APIs;
receive, via the communications module and from the computing device, a signal indicating selection of one of the selectable interface elements for performing the at least one generic API function;
identify the particular API for performing the at least one generic API function;
engage a bridge to translate the at least one generic API function into at least one particular available function of the particular API;
generate at least one API request based on the at least one particular available function of the particular API; and
send, via the communications module and to a server hosting the particular API, the at least one API request to perform the at least one particular available function.

2. The server computer system of claim 1, wherein when generating the at least one API request, the instructions, when executed, further configure the at least one processor to:
retrieve at least one API request template from a database based on the at least one particular available function of the particular API.

3. The server computer system of claim 2, wherein the instructions, when executed, further configure the at least one processor to:
populate one or more dynamic values of the at least one API request template.

4. The server computer system of claim 1, wherein the bridge translates the at least one generic API function into at least one available function of the two or more APIs.

5. The server computer system of claim 1, wherein the graphical user interface include a first selectable interface element for performing a first generic API function using a first API and a second interface element for performing the first generic API function using a second API.

6. The server computer system of claim 1, wherein the particular API for performing the at least one generic API function is identified based on the selection of the one of the selectable interface elements.

7. The server computer system of claim 1, wherein the instructions, when executed, further configure the at least one processor to:
receive, via the communications module and from the server hosting the particular API, a response to the at least one API request.

8. The server computer system of claim 7, wherein the instructions, when executed, further configure the at least one processor to:
update the graphical user interface to display information obtained from the response to the at least one API request.

9. The server computer system of claim 1, wherein the at least one generic API function includes at least one card management function and the particular API includes a card management API.

10. The server computer system of claim 1, wherein the graphical user interface is displayed within a digital wallet application executing on the computing device.

11. A computer-implemented method comprising:
sending, via a communications module and to a computing device, a signal causing the computing device to display a graphical user interface that includes selectable interface elements for performing at least one generic application programming interface (API) function using a particular API of two or more APIs;
receiving, via the communications module and from the computing device, a signal indicating selection of one of the selectable interface elements for performing the at least one generic API function;
identifying the particular API for performing the at least one generic API function;
engaging a bridge to translate the at least one generic API function into at least one particular available function of the particular API;
generating at least one API request based on the at least one particular available function of the particular API; and
sending, via the communications module and to a server hosting the particular API, the at least one API request to perform the at least one particular available function.

12. The computer-implemented method of claim 11, wherein when generating the at least one API request, the method further comprises:
retrieving at least one API request template from a database based on the at least one particular available function of the particular API.

13. The computer-implemented method of claim 12, further comprising:
populating one or more dynamic values of the at least one API request template.

14. The computer-implemented method of claim 11, wherein the bridge translates the at least one generic API function into at least one available function of two or more APIs.

15. The computer-implemented method of claim 11, wherein the graphical user interface include a first selectable interface element for performing a first generic API function using a first API and a second interface element for performing the first generic API function using a second API.

16. The computer-implemented method of claim 11, wherein the particular API for performing the at least one generic API function is identified based on the selection of the one of the selectable interface elements.

17. The computer-implemented method of claim 11, further comprising:
receiving, via the communications module and from the server hosting the particular API, a response to the at least one API request.

18. The computer-implemented method of claim 17, further comprising:
updating the graphical user interface to display information obtained from the response to the at least one API request.

19. (canceled)

20. A non-transitory computer readable storage medium comprising processor-executable instructions which, when executed, configure at least one processor to:
send, via a communications module and to a computing device, a signal causing the computing device to display a graphical user interface that includes selectable interface elements for performing at least one generic application programming interface (API) function using a particular API of two or more APIs;
receive, via the communications module and from the computing device, a signal indicating selection of one of the selectable interface elements for performing the at least one generic API function;
identify the particular API for performing the at least one generic API function;
engage a bridge to translate the at least one generic API function into at least one particular available function of the particular API;
generate at least one API request based on the at least one particular available function of the particular API; and
send, via the communications module and to a server hosting the particular API, the at least one API request to perform the at least one particular available function.

21. The computer-implemented method of claim 11, wherein the bridge defines a mapping between the at least one generic API function and the at least one particular available function of the particular API using artificial intelligence.
